(19) United States
(12) Patent Application Publication
(10) Pub. No.: US 2021/0285579 A1
(43) Pub. Date: Sep. 16, 2021

(54) DUCT CONNECTOR

(71) Applicant: Steere Enterprises, Inc., Tallmadge, OH (US)

(72) Inventors: Doug FRENCH, Stow, OH (US); Eric ANDERSON, Uniontown, OH (US)

(21) Appl. No.: 17/200,825

(22) Filed: Mar. 13, 2021

Related U.S. Application Data
(60) Provisional application No. 62/989,171, filed on Mar. 13, 2020.

(51) Int. Cl. F16L 23/036

(52) U.S. Cl. CPC F16L 23/036

(57) ABSTRACT

A duct connector includes an internal sleeve extending from a first end to a second end and includes a first interior wall and a first exterior wall, the first interior wall defining a first interior volume. An external sleeve extends from a first end to a second end, and includes a second interior wall and a second exterior wall, the second interior wall defining a second interior volume. A portion of the internal sleeve is located within the second interior volume. A portion of a duct is located within the first interior volume. Each of the first end and the second end of the external sleeve is moved between a first position and a second position. When in the first position, a force secures the internal sleeve to the portion of the duct. When in the second position, the duct is movable with respect to the internal sleeve.

### CROSS REFERENCE TO RELATED APPLICATIONS

This application claims priority to U.S. Provisional Patent Application No. 62/989,171 filed on Mar. 13, 2020, entitled “DUCT CONNECTOR,” which is hereby incorporated by reference herein.

### TECHNICAL FIELD

The instant disclosure is generally directed toward a duct connector. For example, the instant disclosure is directed toward a duct connector connecting duct components that are resistant to relatively high temperature fluids and relatively high pressure fluids transported by the duct components.

### BACKGROUND

Duct connectors can be used between various duct or tubing components to maintain relatively reliable, relatively leak-free duct connections. Duct connectors can be used in gasoline-fueled internal combustion engines, diesel-fueled internal combustion engines, etc.

### SUMMARY

This summary is provided to introduce concepts in a simplified form that are further described below in the detailed description. This summary is not intended to identify key factors or essential features of the claimed subject matter, nor is it intended to be used to limit the scope of the claimed subject matter.

According to an aspect, a duct connector includes an internal sleeve extending from a first end to a second end. The internal sleeve includes a first interior wall and a first exterior wall, the first interior wall defining a first interior volume. The duct connector also includes an external sleeve extending from a first end to a second end, the external sleeve having a second interior wall and a second exterior wall, the second interior wall defining a second interior volume. A portion of the internal sleeve is located within the second interior volume such that the first exterior wall contacts the second interior wall. A portion of a first duct is located within the first interior volume, and a portion of a second duct is located within the first interior volume. The first end of the external sleeve is moved between a first position and a second position. When the first end of the external sleeve is in the first position, the first end of the external sleeve applies a first force to the first end of the internal sleeve to secure the internal sleeve to the portion of the first duct. When the first end of the external sleeve is in the second position, the first end of the external sleeve applies a second force to the first end of the internal sleeve such that the portion of the first duct is movable with respect to the internal sleeve. The second end of the external sleeve is moved between a first position and a second position. When the second end of the external sleeve is in the first position, the second end of the external sleeve applies a first force to the second end of the internal sleeve to secure the internal sleeve to the portion of the second duct. When the second end of the external sleeve is in the second position, the second end of the external sleeve applies a second force to the second end of the internal sleeve such that the portion of the second duct is movable with respect to the internal sleeve.

According to an aspect, a duct connector includes an internal sleeve extending from a first end to a second end. The internal sleeve includes a first interior wall and a first exterior wall, the first interior wall defining a first interior volume. The duct connector also includes an external sleeve extending from a first end to a second end, the external sleeve having a second interior wall and a second exterior wall, the second interior wall defining a second interior volume. A portion of the internal sleeve is located within the second interior volume such that the first exterior wall contacts the second interior wall. A portion of a first duct is located within the first interior volume, and a portion of a second duct is located within the first interior volume. At least one of the first end of the external sleeve or the second end of the external sleeve comprises a finger selectively movable from a first position to a second position. When the finger is in the first position, at least one of the first end or the second end of the external sleeve has a first diameter such that movement of at least one of the first duct or the second duct is inhibited with respect to the internal sleeve. When the finger is in the second position, at least one of the first end or the second end of the external sleeve has a second diameter such that the internal sleeve applies a force to at least one of the first duct or the second duct such that at least one of the first duct or the second duct is movable with respect to the internal sleeve.

According to an aspect, a duct connector includes an internal sleeve extending from a first end to a second end, the internal sleeve having a first interior wall and a first exterior wall. The first interior wall defining a first interior volume and a first interlocking feature. The duct connector also includes an external sleeve extending from a first end to a second end, the external sleeve having a second interior wall and a second exterior wall, the second interior wall defining a second interior volume. A portion of the internal sleeve is located within the second interior volume such that the first exterior wall contacts the second interior wall. A portion of a duct is located within the first interior volume and defines a second interlocking feature cooperating with the first interlocking feature.

The following description and annexed drawings set forth certain illustrative aspects and implementations. These are indicative of but a few of the various ways in which one or more aspects can be employed. Other aspects, advantages, and/or novel features of the disclosure will become apparent from the following detailed description when considered in conjunction with the annexed drawings.

### DESCRIPTION OF THE DRAWINGS

FIG. 1 is a perspective view of an example duct connector;

FIG. 2 is a perspective view of a portion of a duct;

FIG. 3 is a cross-section view of the portion of the duct taken along line 3-3 of FIG. 2;

FIG. 4 is a perspective view of an internal sleeve;

FIG. 5 is a cross-section view of the internal sleeve taken along line 5-5 of FIG. 4;

FIG. 6 is a perspective view of an external sleeve;

FIG. 7 is a cross-section view of the external sleeve taken along line 7-7 of FIG. 6;

FIG. 8; is a cross-section view of the external sleeve taken along line 8-8 of FIG. 6;

FIG. 9 is a cross-section view of the duct connector;

FIG. 10 is a cross-section view of the duct connector as part of an assembly;

FIG. 11 is an end view of the duct connector showing a set of fingers at a first diameter;

FIG. 12 is similar to FIG. 11, showing the set of fingers at a second diameter;

FIG. 13 is a cross-section of the duct connector at a second position;

FIG. 14 is a perspective view of the duct connector with clamps; and

FIG. 15 is a perspective view of a duct connector for ducts of differing diameters.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It is evident, however, that the claimed subject matter can be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

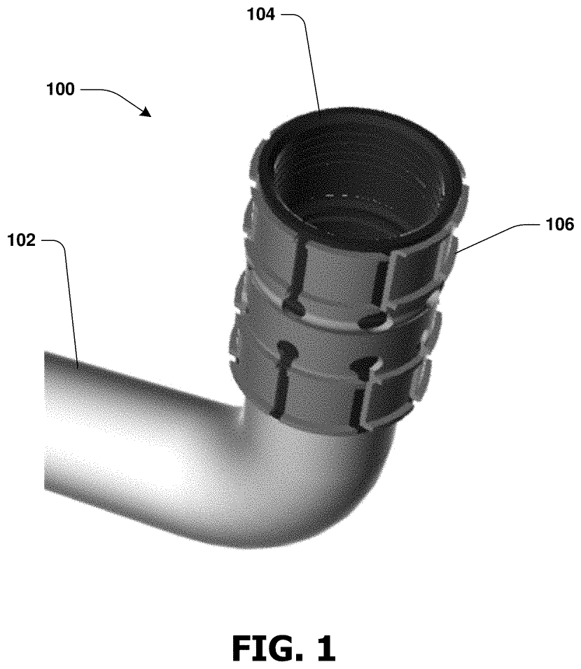

Referring to FIG. 1, a perspective view of an example duct connector 100 is illustrated. The duct connector 100 is assembled to a portion of a first duct 102. The remainder of this disclosure will discuss the duct connector 100 in reference to automotive uses, however, the duct connector 100 can be used in myriad applications with various fluids including, but not limited to, hot-side air induction automotive applications, turbo outlet applications, radiator coolant applications, battery temperature control fluid applications, etc. In other words, the described structures and methods can be used with various liquid duct connections, gas duct connections, etc. Additionally, the present disclosure can be informative of duct connections including relatively high pressure gases and fluids and applications including various temperature ranges including relatively high temperature processes and relatively low temperature processes. The present disclosure is also contemplative of processes requiring duct connectors that are resistant to the deleterious effects of some chemicals including, but not limited to, acids, bases, oxidizers, etc. In some examples, the described structures and methods can also be used in vacuum processes and may require an additional structure as will be readily understood by a person having ordinary skill in the art. It is to be appreciated that the duct connector and methods disclosed herein may be utilized in nearly any environment where a fluid is to be transferred from one compartment to another through a duct and in such a way so as to seal the duct from external contaminants while preventing leakage of the fluid.

In many automotive applications, transfer of fluids (e.g., gases or liquids) is required for proper operation of various components in and around the engine compartment or battery storage areas of the vehicle. Often times, this transfer of fluids requires connections between two ducts, pipes, tubes, etc. These ducts are also commonly constructed of relatively hard and/or rigid materials such as metal or plastic and necessitate a connector that is less rigid and will permit connection of ducts that may vibrate or include two ducts that do not share a common central axis or are not concentric to one another.

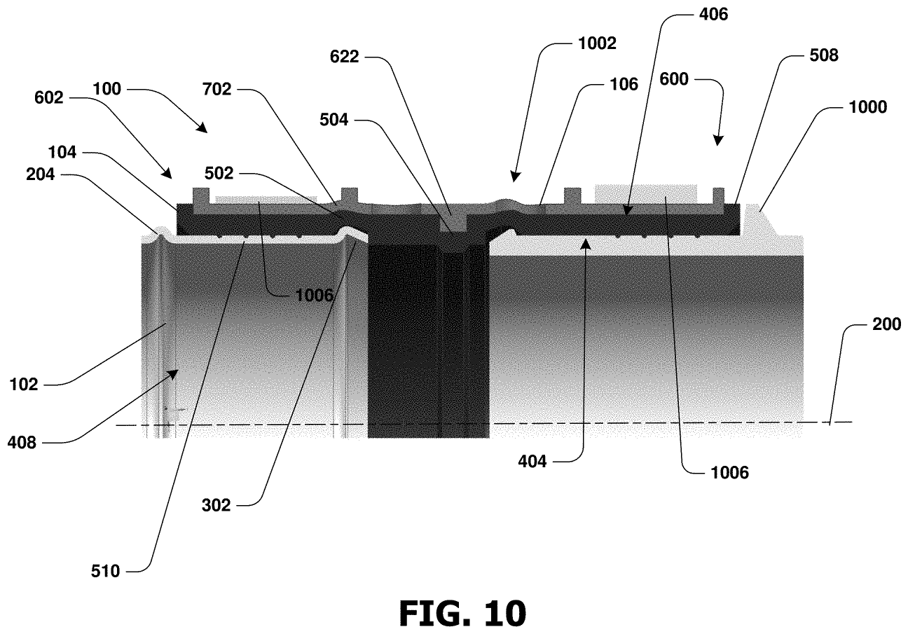

As shown in FIG. 1, the duct connector 100 includes an internal sleeve 104 and an external sleeve 106. The duct connector 100 provides a sealed connection between the first duct 102 and a second duct 1000 (shown in FIG. 10).

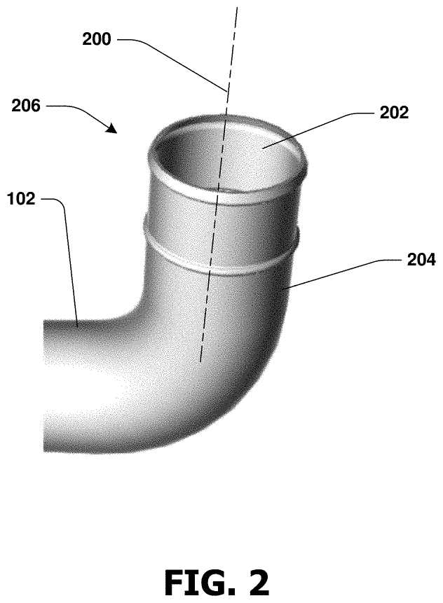

Referring to FIG. 2, a perspective view of the first duct 102 is illustrated. The first duct 102 can be cylindrical as shown and can be centered about a central axis 200. Other examples may include a first duct 102 that is slightly out-of-round, includes a cross-sectional profile that is other than circular, etc. The first duct 102 can include an interior wall 202 and an exterior wall 204. The first duct 102 can extend from a first end 206 to a second end (not shown) that can terminate at an engine component that employs the fluid that passes through the first duct 102 as a typical part of operation of an automotive engine.

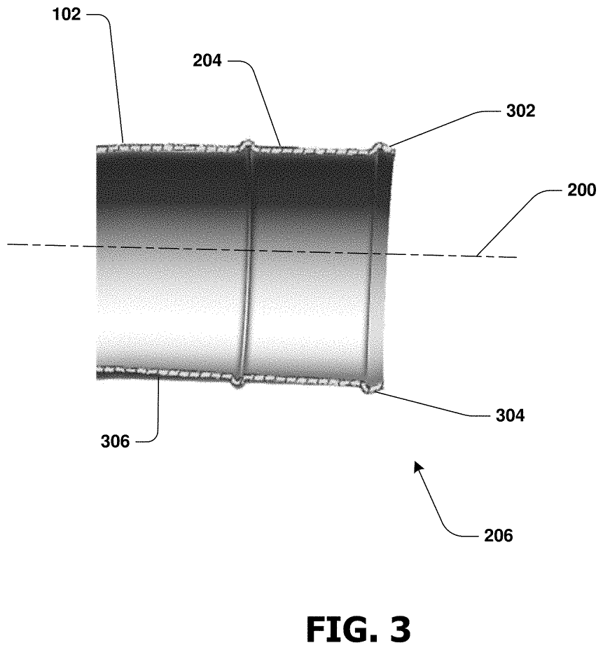

Referring to FIG. 3, a cross-section view of the first duct 102 is illustrated. In some examples, the first duct 102 can include a barb 302 disposed near the first end 206. Although the barb 302 is shown immediately adjacent to the first end 206, skilled artisans will appreciate that the barb 302 may be slightly displaced from the first end 206. The barb 302 can include an angular ramp 304 that extends from the exterior wall 204 or the first end 206. The angle of the angular ramp 304 may range anywhere from 5 degrees to 85 degrees, although it is believed that angles of 30 degrees to 55 degrees may be utilized in most embodiments. Of course, structures other than the described barb 302 can be utilized at the first end 206 of the first duct 102, and the barb 302 is but one example of structure that can cooperate with the internal sleeve 104 as will be further described. Additionally, multiple other structures can be provided along the exterior wall 204 as needed to provide positive location with the internal sleeve 104 or provide additional sealing surfaces to interface with the internal sleeve 104.

For example, the first duct 102 can define an annular groove 306 extending radially inward from the exterior wall 204 of the first duct 102. In some examples, one or more annular grooves 306 can cooperate with structure located on the internal sleeve 104 as will be described below. For the purposes of this disclosure, the term “radially inward” will refer to a direction that is perpendicular to the central axis 200 and extends along any radius from a point on a structure (e.g., the first duct 102) toward the central axis 200. Similarly, the term “radially outward” refers to a direction that is perpendicular to the central axis 200 and extends along any radius from the central axis 200 toward structure located away from the central axis 200 (e.g., the first duct 102).

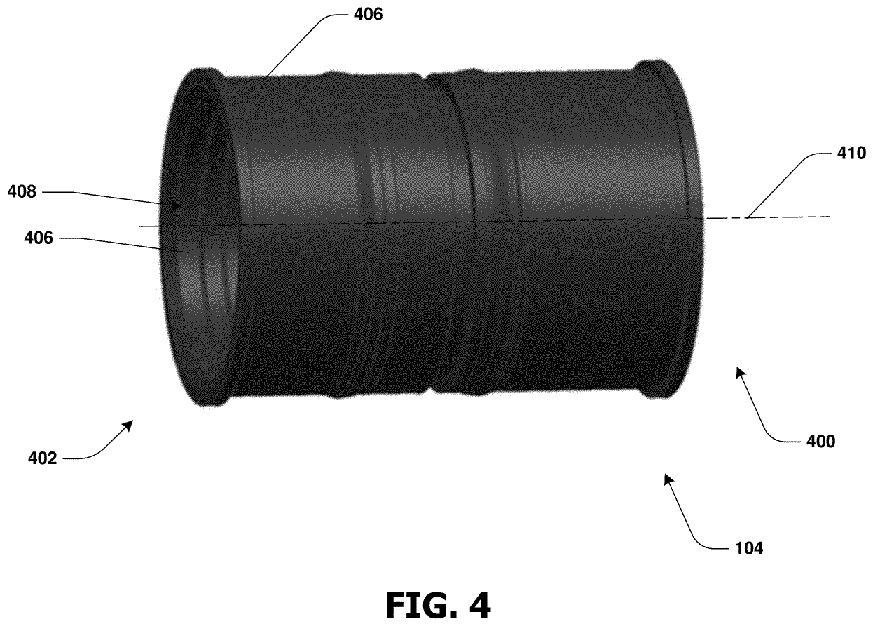

Referring to FIG. 4, a perspective view of the internal sleeve 104 is illustrated. The internal sleeve 104 extends from a first end 400 to a second end 402. The internal sleeve 104 includes a first interior wall 404 and a first exterior wall 406, the first interior wall 404 defines a first interior volume 408. In some examples, the internal sleeve 104 is generally cylindrical, and the internal sleeve 104 can be centered about a central axis 410, and the central axis 410 can be parallel or colinear with the central axis 200 (shown in FIG. 2) of the first duct 102.

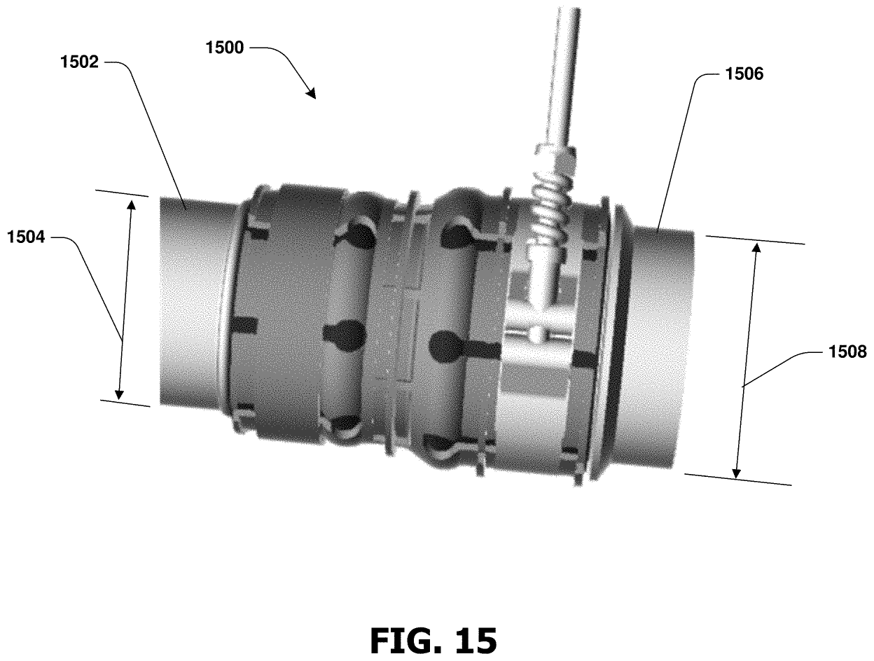

However, it is to be appreciated that shapes and forms other than cylindrical are contemplated for the internal sleeve 104. For example, the internal sleeve 104 can include a first cylindrical form having a first diameter at the first end 400 and a second, different cylindrical form having a second diameter at the second end 402 in order to cooperate with a first duct 102 having a first diameter and a second duct (shown in FIG. 15) having a second diameter, the first diameter having a different length than a length of the second diameter. It is also contemplated that the first end 400 could have a different shape from the second end 402, for example, an oval-shaped end combined with a cylindrical end. Any suitable combination of shapes and sizes is satisfactory for use with the structures and methods of the present disclosure.

The internal sleeve 104 is constructed of a polymeric material and, in particular, a polymeric material which, in most embodiments, is relatively softer than the material utilized for the external sleeve 106. In some examples, the internal sleeve 104 may be made from thermoplastic elastomer which is manufactured by RTP Company under part number RTP™ 6091-65 which has a hardness value of 65 Shore A. Other polymeric materials having similar properties and values may be utilized. Other suitable materials that could be used for the internal sleeve 104 include, but are not limited to: thermoplastic elastomers manufactured by Exxon Mobile part number SATOPRENE™ 101-55, which has a hardness value of 55 Shore A, or Santoprene™ 101-64 which has a hardness value of 64 Shore A. Other suitable thermoplastic elastomers are manufactured by Teknor Apex under part numbers SARLINK™ 4175B, which has a hardness value of 75 Shore A, or SARLINK™ 4180B which has a hardness value of 80 Shore A. The RTP Company also manufactures thermoplastic elastomers RTP™ 6091-65, which has a hardness value of 65 Shore A, and RTP™ 6091-85, which has a hardness value of 85 Shore A. A liquid silicone rubber material manufactured by Wacker Chemical under part number LR 3070/60 which has a hardness value of 60 Shore A may also be utilized. Accordingly, in some embodiments, the material used for the internal sleeve 104 may have a hardness value ranging anywhere from about 45 Shore A to about 90 Shore A, and in other embodiments from about 55 Shore A to about 80 Shore A. In summary, the internal sleeve 104 can comprise materials such as rubber, silicone, and thermoplastic vulcanizates (TPV), but these materials are simply examples, and are not meant to be limiting. Selection of materials of the internal sleeve 104 can depend upon the fluids passing through the ducts that are to be connected by the duct connector 100 (e.g., high temperature requirements, etc.)

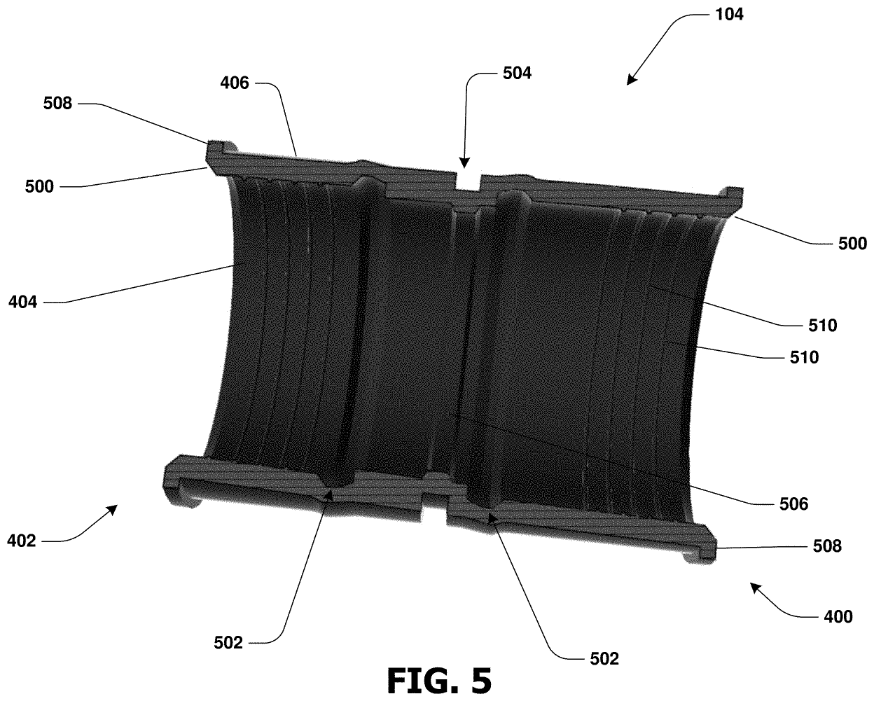

Referring to FIG. 5, a cross-section view of the internal sleeve 104 is illustrated. The internal sleeve 104 includes the first end 400 and the second end 402 as previously noted. One or both of the first end 400 and the second end 402 can define an end chamfer 500. In some examples, the end chamfer 500 may extend at about a 45-degree angle, although other angles may be employed. Skilled artisans will appreciate that the end chamfer 500 is employed so as to allow or facilitate mounting of the completed duct connector 100 onto an appropriate duct, such as the first duct 102. In any event, the end chamfer 500 extends into the first interior volume 408.

In some examples, the internal sleeve 104 defines a first interlocking feature 502. The first interlocking feature 502 can include an annular groove as shown that extends radially outward from the first interior wall 404. The first interlocking feature 502 can cooperate with the barb 302 of the first duct 102 as previously described to provide a tactile indication of correct placement of the duct connector 100 onto the first duct 102 as will be described below. In some examples, the annular groove of the first interlocking feature 502 and the barb 302 provide a snap fit for the duct connector 100 to the first duct 102. Of course, the annular groove of the first interlocking feature 502 and the barb 302 are only examples of cooperating structure between the first duct 102 and the internal sleeve 104, and any suitable cooperating structure is satisfactory.

In some examples, the internal sleeve 104 can include an annular groove 504 extending radially inward from the first exterior wall 406. The annular groove 504 can be configured to cooperate with structure defined by the external sleeve 106 as will be described below. In some examples, the internal sleeve 104 includes a rib 506 extending radially inward from the first interior wall 404. The rib 506 can provide structural stability and additional strength to the internal sleeve 104 in the section of the internal sleeve 104 adjacent to the annular groove 504.

Remaining with FIG. 5, the internal sleeve 104 can also include an end flange 508 at one or both the first end 400 and the second end 402 of the internal sleeve 104. The end flange 508 can extend radially outward from the first exterior wall 406 to provide positive location with the external sleeve 106 as will be shown in other figures.

In some examples, the internal sleeve 104 can also include structure extending radially inward from the first interior wall 404 such as a bead 510. In some examples, the bead 510 can contact the exterior wall 204 of the first duct 102. In some examples, the bead 510 can cooperate with the annular groove 306 of the first duct 102 to provide improved sealing functionality to the duct connector 100.

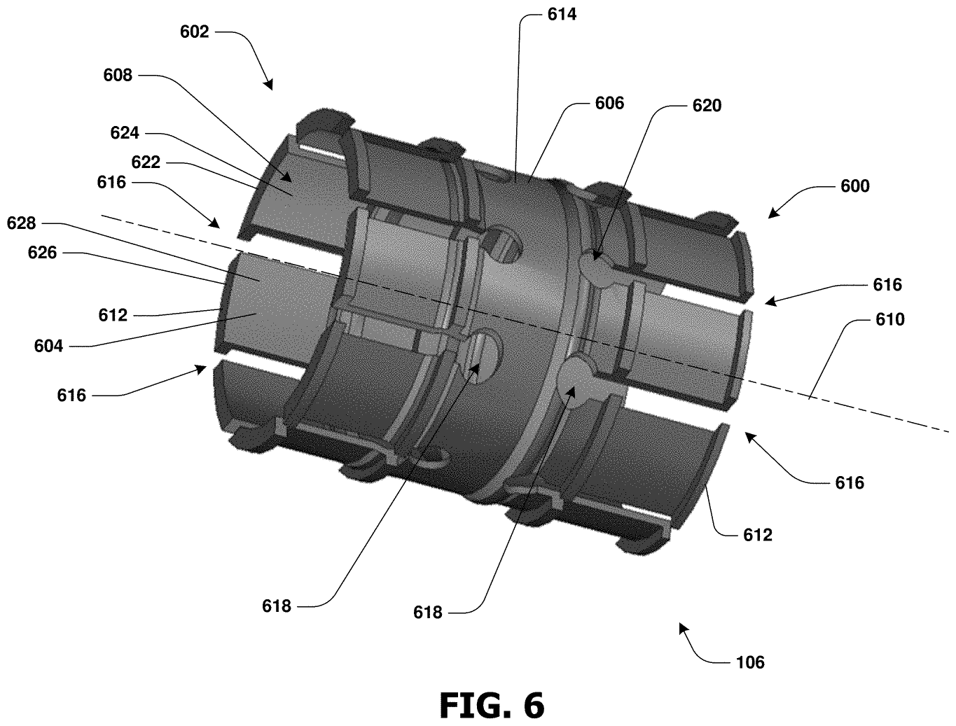

Referring to FIG. 6, is a perspective view of the external sleeve 106 is illustrated. The external sleeve extends from a first end 600 to a second end 602. The external sleeve 106 includes a second interior wall 604 and a second exterior wall 606. The second interior wall 604 defines a second interior volume 608. In some examples, the external sleeve 106 is generally cylindrical, however, other shapes and forms are contemplated. Similar to the internal sleeve 104, any suitable combination of shapes and sizes is satisfactory for use with the structures and methods of the present disclosure. The external sleeve 106 can be centered about a central axis 610, and the central axis 610 can be parallel or colinear with the central axis 200 (shown in FIG. 2) of the first duct 102.

In some examples, the external sleeve 106 is constructed of thermoplastic or nylon materials and, in particular, materials which, in some examples, is relatively harder than the material utilized for the internal sleeve 104. In some examples, the external sleeve is manufactured utilizing a blow-molding process, an extrusion or an injection molding process. The external sleeve 106 may be made from a polymeric material such as polypropylene manufactured by Lyondell Bassel under part number Pro-Fax™ SV152 which has a hardness value of 78 Shore D. Skilled artisans will appreciate that other polymeric materials having similar properties and values may also be utilized. Other suitable materials that could be used for the external sleeve 106 can include: nylon manufactured by BASF under the part number Ultrmid™ 827G which has a hardness value of 121 Shore R; nylon 6/6 manufactured by DuPont under part number Zytel™ BM70G20HSLX which has a hardness value of 120 Shore R; or thermoplastic elastomer manufactured by Teknor Apex under part number Sarlink™ 4190B which has a hardness value of 90 Shore A. Accordingly, in some examples the material used for the external sleeve 106 may have a hardness value ranging anywhere from about 70 Shore A to about 130 Shore R, and in some examples from about 90 Shore A to about 121 Shore R.

In some examples, the external sleeve 106 is injection molded and made of hard thermoplastic materials such as Nylon or Polypropylene, depending on temperatures and pressures of the fluid within the first duct 102. The materials can be unfilled or filled with common strengthening media such talc or glass.

Remaining with FIG. 6, the external sleeve 106 includes a finger 612 that extends axially away from a central portion 614 of the external sleeve 106. For the purposes of this disclosure, the terms “axially away” and “axial” will indicate a direction parallel to the central axis 610 of the external sleeve 106 which can be parallel or even colinear with the central axis 200. The central portion 614 is characterized by a portion of the external sleeve 106 that is not divided into individual finger 612 areas. The central portion 614 can be cylindrical.

The external sleeve 106 defines an axial slot 616 adjacent to the finger 612. The axial slot 616 extends from the first end 600 of the external sleeve 106 toward the central portion 614 to an end point 618. The axial slot 616 can be oriented in an axial direction and pass through the second interior wall 604 and the second exterior wall 606 such that each finger 612 can selectively flex or pivot toward and away from the second interior volume 608. This flexing can alter the diameter of the first end 600 such that the duct connector 100 can both pass onto the first duct 102 and also provide force radially inward toward the central axis 200 to secure the external sleeve 106 to the internal sleeve 104 and to the first duct 102.

In some examples, the end point 618 can define a stress relief feature 620 that can include an aperture having a radius that is larger than a width of the axial slot 616. The stress relief feature 620 can reduce any stress concentration points at the end of the axial slot 616 during flexing of the finger 612. The stress relief feature 620 can also minimize the width of the finger 612 where it meets the central portion 614 so that less force is required to flex the finger 612. All of the features of the finger 612 as described can be located on the second end 602 of the external sleeve 106 as well as the first end 600. As such, the finger 612 can be located on both ends 600, 602 of the external sleeve 106.

In some examples, the external sleeve 106 includes a pair of fingers 612, and the external sleeve 106 defines the axial slot 616 between the pair of fingers 612. As noted previously, the axial slots 616 and the stress relief features 620 (e.g., a relatively large radius at the end point 618) aid in expansion of the duct connector 100 during installation and collapse or contraction of the duct connector 100 during a compression operation.

Remaining with FIG. 6, the duct connector of claim 14, wherein each finger 612 of the pair of fingers includes a first finger 622 having a first interior side 624 having a first area and a second finger 626 having a second interior side 628 having a second area equal to the first area. This equal area relationship can be true for all of the fingers 612, and, indeed, the first finger 622, the second finger 626, and the remaining fingers 612 can be identical. The equal interior side areas of the fingers 612 can promote uniform pressure application to the interior sleeve 104 around its first exterior wall 204. As shown in FIG. 6, the external sleeve 106 can include several fingers 612 and axial slots 616 on the first end 600 and the second end 612. The number of fingers 612 and the width of the axial slots 616 can be engineered to minimize the volume of the more pliable internal sleeve 104 into the axial slots 616 during the compression operation.

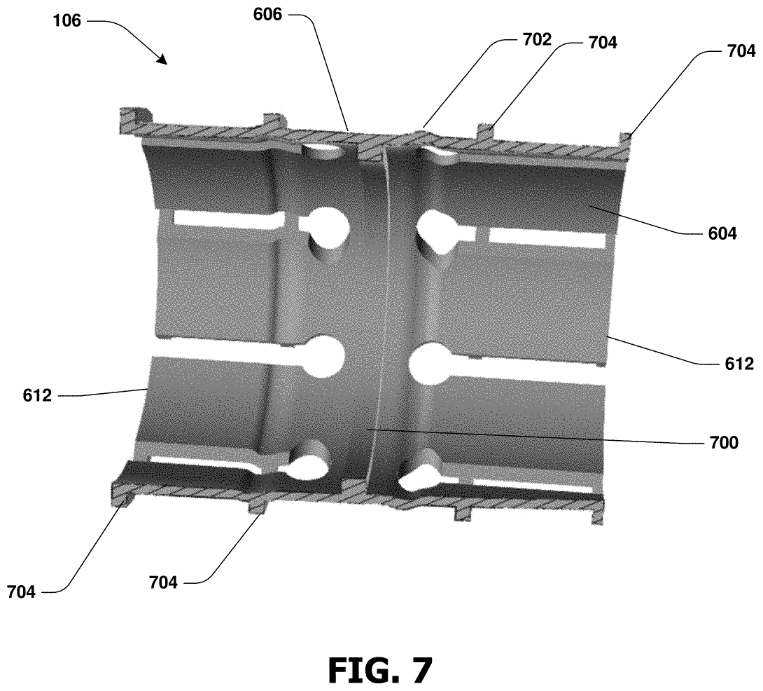

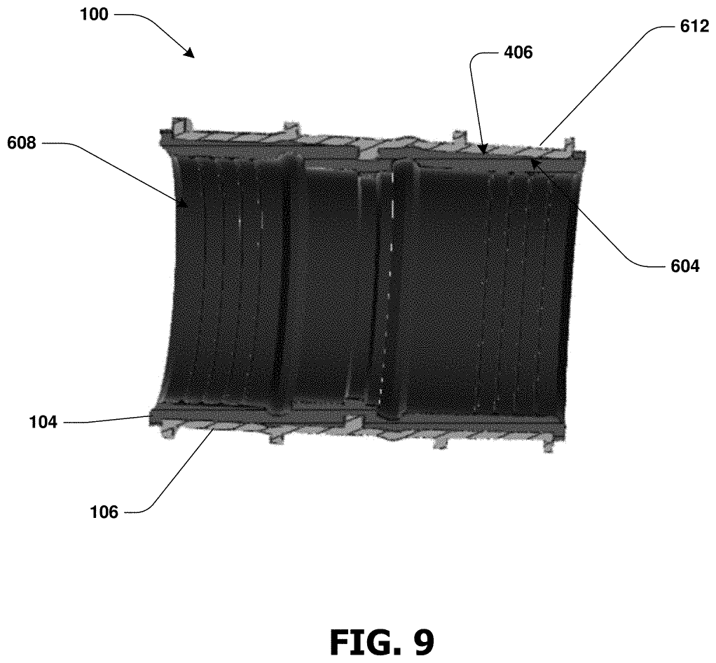

Referring to FIG. 7, a cross-section view of the external sleeve 106 is illustrated. This cross-section view is through the fingers 612. The second interior wall 604 of the external sleeve 106 defines an annular ridge 700 extending radially inward from the second interior wall 604. The annular ridge 700 is configured to cooperate with the annular groove 504 of the internal sleeve 104 and is shown in FIGS. 9 and 10. As shown, the annular ridge 700 can fit into the annular groove 504 to limit relative axial motion between the external sleeve 106 and the internal sleeve 104. While not required, in some examples, the surfaces of the annular ridge 700 and the annular groove 504 can include an amount of an adhesive to maintain the external sleeve 106 and the internal sleeve 104 in contact with each other.

Additionally, the second interior wall 604 of the external sleeve 106 can define an annular groove 702 extending radially outward that is configured to cooperate with the first interlocking feature 502 of the internal sleeve 104. The cooperation between the annular groove 702 and the first interlocking feature 502 (e.g., the annular groove as shown) can ease passage of the external sleeve 106 (and the duct connector 100) over the barb 302 and seal the first interlocking feature 502 with the barb 302.

In some examples, at least one finger 612 includes a clamp guide 704 extending radially outward from the second exterior wall 606 of the external sleeve 106 (e.g., an outside surface of the finger 612). In these and other examples, the clamp guide 704 can limit relative motion between a clamp (shown in FIG. 15) and the external sleeve 106 in an axial direction. In some examples, each finger 612 can include a clamp guide 704 for each axial side of a clamp.

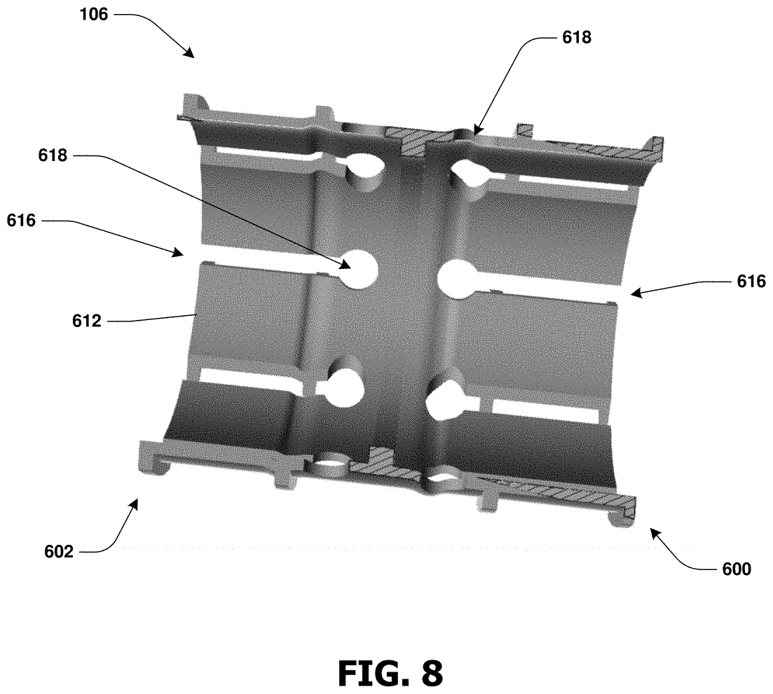

Referring to FIG. 8, a cross-section view of the external sleeve 106 is illustrated. This cross-section view passes through the axial slots 616 between the fingers 612 to show the length of the axial slots 616 from the first end 600 or the second end 602 to the respective end points 618.

Referring to FIG. 9, a cross-section view of the duct connector 100 is illustrated including the internal sleeve 104 located inside the external sleeve 106. As shown, a portion of the internal sleeve 104 is located within the second interior volume 608 such that the first exterior wall 406 contacts the second interior wall 604. It can be beneficial for the portion of the external sleeve 106 at the finger 612 location (e.g., the first area and the second area as described above) to enable a minimal amount of sliding contact with the first exterior wall 406 of the internal sleeve 104. This helps apply uniform pressure and deformation of the internal sleeve 104 during application of a pressure as described below.

Referring to FIG. 10, a cross-section view of the duct connector 100 as part of an assembly is illustrated. As shown, a portion of the first duct 102 is located within the first interior volume 408. Similarly, a portion of a second duct 1000 is located within the first interior volume 408 at an opposing end of the duct connector 100. As shown, there is physical cooperation between the annular groove 702 and the first interlocking feature 502 and the barb 302 to help seal the first interlocking feature 502 with the barb 302. Similar structures can be included on the second side of the duct connector 100 as shown in area 1002.

Details of FIG. 10 also show cooperation between the annular ridge 622 and the annular groove 504 to limit relative axial motion between the external sleeve 106 and the internal sleeve 104. Additionally, the internal sleeve 104 structure extending radially inward from the first interior wall 404 such as a bead 510 is shown in contact the exterior wall 204 of the first duct 102. As previously noted, in some examples, the bead 510 can cooperate with the annular groove 306 of the first duct 102 to provide improved sealing functionality to the duct connector 100, however, the annular groove 306 is not necessarily present in all examples.

In some examples, the internal sleeve 104 extends axially from at least one of the first end 600 of the external sleeve 106 or the second end 602 of the external sleeve 106. In some examples, the first exterior wall 406 of the internal sleeve 104 defines the end flange 508 extending radially outward from the first exterior wall 406 at one or both of the first end 400 of the internal sleeve 104 and the second end 402 of the internal sleeve 104. In these examples, the end flange 508 extends beyond at least one of the first end 600 of the external sleeve 106 or the second end 602 of the external sleeve 106. FIG. 10 also includes representations of clamps 1006 applied to the first end 600 of the external sleeve 106 and the second end 602 of the external sleeve 106. The clamps 1006 are utilized to apply a radially inward pressure on the external sleeve 106, the internal sleeve 104, and the ducts 102, 1000.

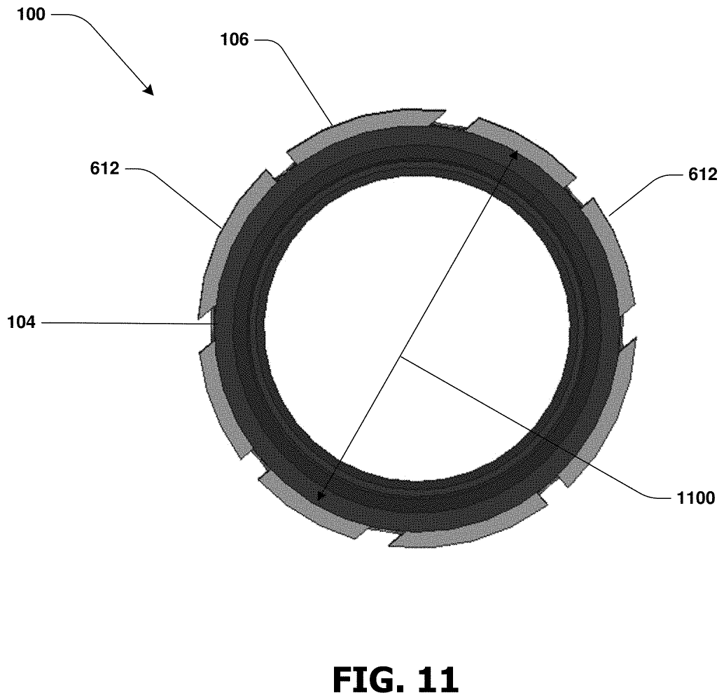

Referring to FIG. 11 is an end view of the duct connector 100 showing a set of fingers 612 at a first diameter 1100. The fingers 612 located at this first diameter 1100 can be considered the first position for the fingers 612. When the finger 612 (or fingers) is in the first position, at least one of the first end 600 or the second end 602 of the external sleeve 106 has a first diameter 1100 such that movement of at least one of the first duct 102 or the second duct 1000 is inhibited with respect to the internal sleeve 104. In this first position, the duct connector 100 can physically entrap the first duct 102 and the second duct 1000. In some examples, the clamps 1006 can apply suitable pressure in a radially inward direction to accomplish this physical entrapment. It is contemplated that the properties of the external sleeve 106 can achieve the suitable pressure without the application of a clamp in some examples.

During application of the duct connector 100, the first end 600 of the external sleeve 106 is moved between the first position and a second position. This can also be described as the duct connector 100 passing axially over the portion of the first duct 102 or the second duct 1000. When the first end 600 of the external sleeve 106 is in the first position, the first end 600 of the external sleeve 106 applies a first force to the first end 400 of the internal sleeve 104 to secure the internal sleeve 104 to the portion of the first duct 102. When the first end 600 of the external sleeve 106 is in the second position (e.g., the clamp 1006 is not applying a force to the external sleeve 106 or the duct connector 100 is passing over the barb 302 to spread the fingers radially outward), the first end 600 of the external sleeve 106 applies a second force to the first end 400 of the internal sleeve 104 such that the portion of the first duct 102 is movable with respect to the internal sleeve 104. In other words, in the second position, the duct connector 100 does not physically entrap the first duct 102.

Similarly, the second end 602 of the external sleeve 106 is moved between a first position and a second position, wherein when the second end 602 of the external sleeve 106 is in the first position, the second end 602 of the external sleeve 106 applies a first force to the second end 402 of the internal sleeve 104 to secure the internal sleeve 104 to the portion of the second duct 1000, and when the second end 602 of the external sleeve 106 is in the second position, the second end 602 of the external sleeve 106 applies a second force to the second end 402 of the internal sleeve 104 such that the portion of the second duct 1000 is movable with respect to the internal sleeve 104.

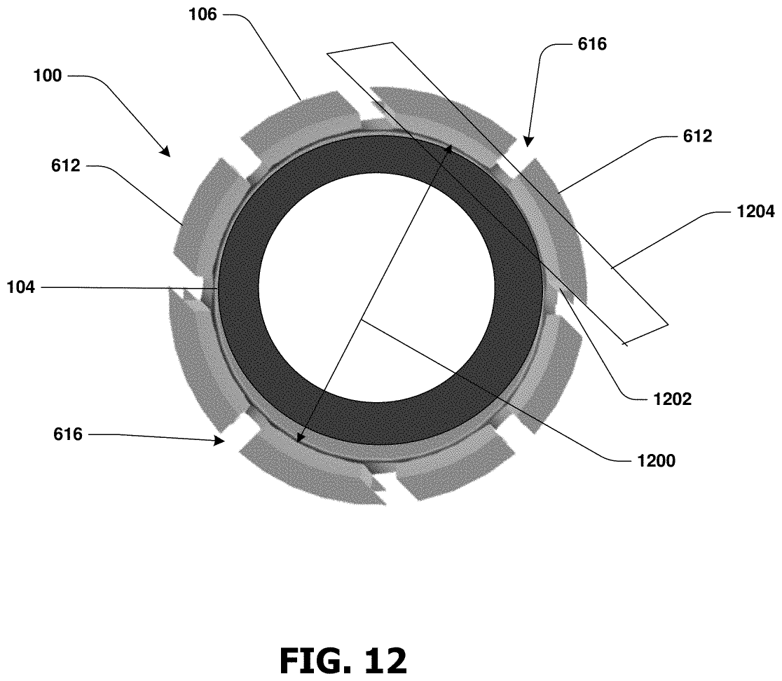

Referring to FIG. 12, and end view of the duct connector 100 is illustrated to show the fingers at a second diameter 1200 or in the second position. This second position is when the duct connector 100 does not physically entrap the first duct 102 or the second duct 1000. The view of FIG. 12 and deformation of the fingers 612 away from the first exterior wall 406 of the internal sleeve 104 may be exaggerated to show the difference between the first diameter 1100 (shown in FIG. 11) and the second diameter 1200. In some examples, the fingers 612 do not separate from the first exterior wall 406 of the internal sleeve 104. As previously noted, the axial slots 616 and stress relief features 620 enable expansion of an inside diameter of the fingers 612 during installation (e.g., second diameter 1200) and collapse of the inside diameter of the fingers 612 during clamp compression (e.g., first diameter 1100).

FIG. 12 also shows that at least one of the axial slots 616 can be defined by an axial slot wall 1202 that is not extending radially inward or radially outward. In some examples, the axial slot wall 1202 is lying on a plane 1204 that is non-radial relative to the central axis 610 of the external sleeve 106. In other words, the axial slot wall 1202 can be oriented in a direction to facilitate slides in molds used to form the external sleeve 106.

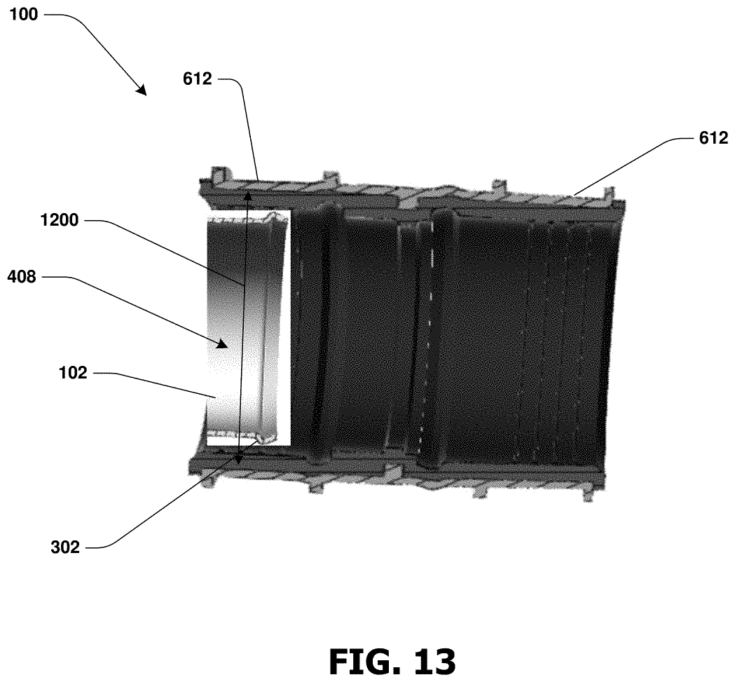

Referring to FIG. 13, a cross-section of the duct connector 100 at the second position is illustrated. Here, the first duct 102 is not fully inserted into the first interior volume 408. As such, the barb 302 at the end of the first duct 102 acts to force the fingers 612 to the second position (e.g., the second diameter 1200). As the first duct 102 reaches its proper installation location, the barb 302 can snap fit into place and the fingers 612 can be placed in the first position as shown in FIG. 10 to physically entrap the first duct 102 within the duct connector 100.

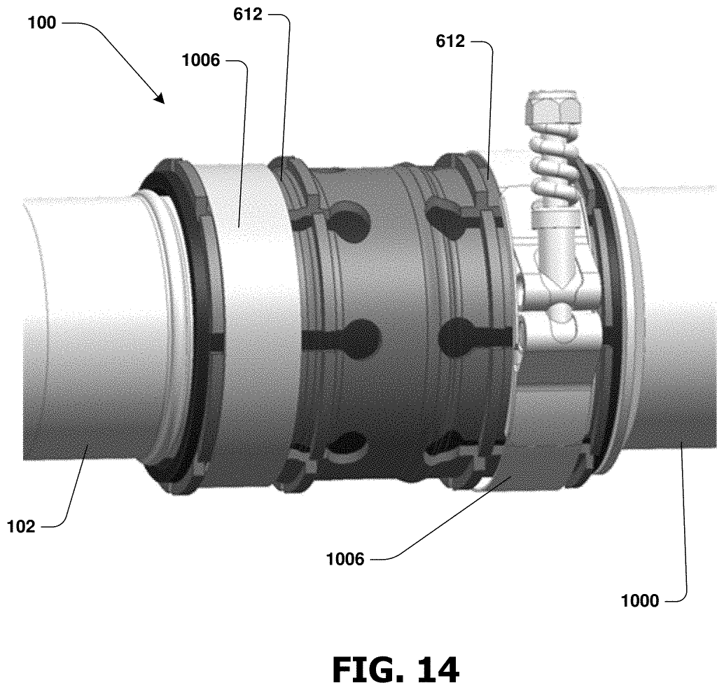

Referring to FIG. 14, a perspective view of the duct connector 100 with clamps 1006 placing the fingers 612 in the first position is illustrated. In this view, the entire assembly is together to secure the first duct 102 and the second duct 1000 in a leak-free sealed position. The duct connector 100 can achieve the seal between the first duct 102 and the second duct 1000 to facilitate transfer of various fluids (e.g. gases or liquids) between components using such fluids.

Referring to FIG. 15 a perspective view of an example duct connector 1500 includes a first duct 1502 having a first diameter 1504. The duct connector 1500 mates the first duct 1502 to a second duct 1506 having a second diameter 1508. In some examples, the first diameter 1504 is not equal to the second diameter 1508. As such the duct connector 1500 can join and seal ducts of differing diameters.

A number of benefits can be realized by the presently described apparatus and methods. In some examples, the duct connector can provide a lower cost alternative to braided hose connections for automotive engines. Also, the duct connector can provide a longer design life or service life for connections between ducts. Additionally, the described duct connector can use a variety of clamps. Furthermore, the described structures can provide positive clamp orientation features (e.g., clocking) for holding the clamp in place before installing and tactical installation feedback (e.g., snap fit sensations to the operator).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first component and a second component generally correspond to component A and component B or two different or two identical components or the same component.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally to be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A duct connector comprising:
an internal sleeve extending from a first end to a second end, the internal sleeve having a first interior wall and a first exterior wall, the first interior wall defining a first interior volume; and
an external sleeve extending from a first end to a second end, the external sleeve having a second interior wall and a second exterior wall, the second interior wall defining a second interior volume, wherein:
a portion of the internal sleeve is located within the second interior volume such that the first exterior wall contacts the second interior wall,
a portion of a first duct is located within the first interior volume,
a portion of a second duct is located within the first interior volume,
the first end of the external sleeve is moved between a first position and a second position, wherein when the first end of the external sleeve is in the first position, the first end of the external sleeve applies a first force to the first end of the internal sleeve to secure the internal sleeve to the portion of the first duct, and when the first end of the external sleeve is in the second position, the first end of the external sleeve applies a second force to the first end of the internal sleeve such that the portion of the first duct is movable with respect to the internal sleeve, and
the second end of the external sleeve is moved between a first position and a second position, wherein when the second end of the external sleeve is in the first position, the second end of the external sleeve applies a first force to the second end of the internal sleeve to secure the internal sleeve to the portion of the second duct, and when the second end of the external sleeve is in the second position, the second end of the external sleeve applies a second force to the second end of the internal sleeve such that the portion of the second duct is movable with respect to the internal sleeve.

2. The duct connector of claim 1, wherein the internal sleeve has a first hardness and the external sleeve has a second hardness, wherein the second hardness is greater than the first hardness.

3. The duct connector of claim 1, wherein the internal sleeve has a hardness value of between about 45 Shore A to about 90 Shore A.

4. The duct connector of claim 1, wherein the external sleeve has a hardness value of between about 70 Shore A to about 130 Shore R.

5. The duct connector of claim 1, wherein:
the second interior wall of the external sleeve defines a first flange extending radially inward from the second interior wall, and
the first exterior wall of the internal sleeve defines an annular groove configured to cooperate with the first flange to reduce relative motion between the internal sleeve and the external sleeve.

6. The duct connector of claim 1, wherein the internal sleeve extends axially from at least one of the first end of the external sleeve or the second end of the external sleeve.

7. The duct connector of claim 1, wherein the first exterior wall of the internal sleeve defines a flange extending radially outward from the first exterior wall at at least one of the first end of the internal sleeve or the second end of the internal sleeve such that the second flange extends beyond at least one of the first end of the external sleeve or the second end of the external sleeve.

8. The duct connector of claim 1 comprising a clamp cooperating with at least one of the first end of the external sleeve or the second end of the external sleeve to apply a force to the second exterior wall of the external sleeve, the force applied to reduce relative motion between the internal sleeve and at least one of the portion of the first duct or the portion of the second duct in an axial direction.

9. A duct connector comprising:
an internal sleeve extending from a first end to a second end, the internal sleeve having a first interior wall and a first exterior wall, the first interior wall defining a first interior volume; and
an external sleeve extending from a first end to a second end, the external sleeve having a second interior wall and a second exterior wall, the second interior wall defining a second interior volume, wherein:
a portion of the internal sleeve is located within the second interior volume such that the first exterior wall contacts the second interior wall,
a portion of a first duct is located within the first interior volume,
a portion of a second duct is located within the first interior volume,
at least one of the first end of the external sleeve or the second end of the external sleeve comprises a finger selectively movable from a first position to a second position, wherein:
when the finger is in the first position, at least one of the first end or the second end of the external sleeve has a first diameter such that movement of at least one of the first duct or the second duct is inhibited with respect to the internal sleeve, and
when the finger is in the second position, at least one of the first end or the second end of the external sleeve has a second diameter such that the internal sleeve applies a force to at least one of the first duct or the second duct such that at least one of the first duct or the second duct is movable with respect to the internal sleeve.

10. The duct connector of claim 9, wherein the external sleeve defines an axial slot adjacent to the finger, the slot extending from the first end of the external sleeve to an end point.

11. The duct connector of claim 10, the external sleeve comprising an axial slot wall defining the axial slot, the axial slot wall lying on a plane that is non-radial relative to a central axis of the external sleeve.

12. The duct connector of claim 10, wherein the external sleeve defines a stress relief feature at the end point to reduce stress concentration between the finger and a central portion of the external sleeve.

13. The duct connector of claim 9, the finger comprising a clamp guide extending radially outward from the second exterior wall of the external sleeve, the clamp guide configured to limit relative motion between a clamp and the external sleeve in an axial direction.

14. The duct connector of claim 9, the external sleeve comprising a pair of fingers, the external sleeve defining an axial slot between the pair of fingers.

15. The duct connector of claim 14, wherein each finger of the pair of fingers includes a first finger having a first interior side having a first area and a second finger having a second interior side having a second area equal to the first area.

16. The duct connector of claim 9 comprising a clamp cooperating with at least one of the first end of the external sleeve or the second end of the external sleeve to apply a force to the second exterior wall of the external sleeve, the force applied to reduce relative motion between the internal sleeve and at least one of the portion of the first duct or the portion of the second duct in an axial direction.

17. The duct connector of claim 16, the portion of the first duct defining an annular groove extending radially inward from an exterior wall of the first duct, wherein:
the force applied to the second exterior wall of the external sleeve urges a portion of the internal sleeve into the annular groove.

18. A duct connector comprising:
an internal sleeve extending from a first end to a second end, the internal sleeve having a first interior wall and a first exterior wall, the first interior wall defining a first interior volume and a first interlocking feature; and
an external sleeve extending from a first end to a second end, the external sleeve having a second interior wall and a second exterior wall, the second interior wall defining a second interior volume, wherein:
a portion of the internal sleeve is located within the second interior volume such that the first exterior wall contacts the second interior wall, and
a portion of a duct is located within the first interior volume and defines a second interlocking feature cooperating with the first interlocking feature.

19. The duct connector of claim 18, wherein:
the portion of the duct includes a barb at an end of the portion of the duct,
the first interior wall of the internal sleeve defines an annular groove extending radially outward from the first interior wall,
the barb of the duct is separated from the annular groove of the internal sleeve when the internal sleeve is in a first position, and
the barb of the duct extends into the annular groove of the internal sleeve when the internal sleeve is in a second position.

20. The duct connector of claim 19, wherein:
the first exterior wall of the internal sleeve defines an annular ring extending radially outward from the first exterior wall, the annular ring located radially outward from the annular groove of the internal sleeve,
the second interior wall of the external sleeve defines an annular groove extending radially inward from the second interior wall, and
the annular ring of the internal sleeve cooperating with the annular groove of the external sleeve.
